(19) United States
(12) Patent Application Publication
(10) Pub. No.: US 2005/0243377 A1
(43) Pub. Date: Nov. 3, 2005

(54) Method for generating non-printing dots in a screened representation of an image

(76) Inventor: Rudolf Bartels, Boortmeerbeek (BE)

Correspondence Address: AGFA CORPORATION;LAW & PATENT DEPARTMENT, 200 BALLARDVALE STREET, WILMINGTON, MA, 01887, US

(21) Appl. No.: 11/135,901

(22) Filed: May 24, 2005

(30) Foreign Application Priority Data
Nov. 25, 2002 (EP) 02102636.4
Feb. 4, 2003 (EP) 03100220.7

(51) Int. Cl. G06F 15/00; G06K 15/00

(52) U.S. Cl. 358/3.12; 358/1.9

(57) ABSTRACT

A method for generating a bitmap from an image for image reproduction, the bitmap having both screened and non-screened data, includes the steps of: generating a set of contiguous microdots of the bitmap, wherein the set is selected from the group of a set of contiguous microdots forming an image dot being part of the screened data and a set of contiguous microdots forming an entity of contiguous microdots being part of the non-screened data; generating a non-printing dot in the set of contiguous microdots, depending on a specific characteristic selected from a characteristic of the image and a characteristic of the set of contiguous microdots; and applying a morphological filter to the set of contiguous microdots for preserving fine details in the reproduction of the image.

### FIELD OF THE INVENTION

The invention relates to generating a bitmap from an original image for printing a reproduction of said original image.

### BACKGROUND OF THE INVENTION

Patent application PR-A-2 660 445 discloses a method for making films or printing plates wherein a portion of the inkphilic surfaces of the obtained printing plates contain small, non-inkphilic surfaces. One of the objects of this method is to effect a better release of the paper from the printing rolls, in an offset press.

However, the method as described in PR-A-2 660 445 has drawbacks, as stated in patent U.S. Pat. No. 6,406,833. To cope with these drawbacks, U.S. Pat. No. 6,406,833, which is included herein by reference, discloses to locate the small, non-inkphilic surfaces in accordance with a frequency-modulated screen.

### SUMMARY OF THE INVENTION

The present invention is a method for generating a bitmap from an original image for printing a reproduction of the original image, as claimed in independent claims 1 and 12. Preferred embodiments of the invention are set out in the dependent claims. Preferably, a method in accordance with the invention is implemented by a computer program as claimed in claim 16.

The meaning of some terms used in the claims is now amplified or explained.

Many reproduction devices are not capable of reproducing a continuous range of tones. For example, offset printing or inkjet printing methods can either deposit ink or not. In order to reproduce an original image, the image is therefore transformed to a set of binary single color images, each referred to as a “bitmap”, or an “electronically generated image”. Each bitmap comprises “microdots”, that preferably form a two-dimensional array, and that are the smallest addressable units in a bitmap. These microdots may either be turned on or not, thus determining, e.g. on an offset press, at what locations ink will be deposited to reproduce the original image. A “set of contiguous microdots” denotes in this document a number of contiguous microdots that correspond to an area where ink will be deposited to reproduce the original image.

A bitmap may contain screened data, non-screened data, or both. Screening, which is also called halftoning, breaks the original image down into a series of dots, called “image dots” in this document. Screening allows to simulate continuous tones on reproduction devices that are not capable of reproducing a continuous range of tones. Two major classes of screening methods are AM screening (Amplitude Modulated screening) and FM screening (Frequency Modulated screening). A bitmap may also contain non-screened data. E.g. full color areas, also called “solid areas” in this document, and text, are usually not screened; they are represented in a bitmap by a set of contiguous microdots that form an unbroken block that is not split up into image dots. Screened data, on the other hand, contains sets of contiguous microdots that form image dots.

A “printing plate precursor” is an imaging material that can be used as a printing plate after one or more treatment steps, that include image-wise exposure and possibly processing. A “direct-to-plate” exposure is an exposure wherein the printing plate is directly exposed, without the intermediate step of writing the image to film. Direct-to-plate exposure is also called computer to plate (CtP): the electronically generated image is written directly to the plate, e.g. in an apparatus called a platesetter. In computer to film (CtF), the electronically generated image is written to film, e.g. in an imagesetter, and subsequently the image on film is copied to the plate. Both in a platesetter and in an imagesetter, the printing plate precursor is thus exposed in accordance with a bitmap of the original image.

A “non-printing dot” means, in this document, a dot that corresponds to an area that does not accept ink on the printing plate with which the image will be printed. A non-printing dot thus corresponds to a non-inkphilic surface in PR-A-2 660 445, mentioned above. A non-printing dot comprises one or more microdots. That a non-printing dot is “in” a set of contiguous microdots means that either the non-printing dot is totally surrounded by microdots of the set, or that the microdots of the non-printing dot and the microdots of the set overlap, so that the area of the set of contiguous microdots becomes smaller after combination with the non-printing dot (which corresponds to the “lightening” of an image by means of non-printing dots, as discussed in U.S. Pat. No. 6,406,833 and FR-A-2 660 445, referred to already above). A non-printing dot may be in an image dot.

A method in accordance with the invention offers the advantage of better print quality, because the location and the size of the non-printing dots are well-controlled. Another advantage is saving ink during printing. Yet another advantage is a better release of the printing substrate, such as paper, from the printing rolls, e.g. in offset printing.

In a particular embodiment of the invention, direct-to-plate exposure is used. In this way, the exposure of the set of contiguous microdots of the bitmap and of the non-printing dots proceeds simultaneously, in a single step. There is thus no intermediate step of copying to film; in such an intermediate step, dot sizes may change and, if the set of contiguous microdots and the non-printing dots are not on the same film, their relative location on the plate may also be affected.

In one embodiment of the invention, at least one and preferably all the non-printing dots are generated conditionally, so that print quality is not adversely affected by their location, their size or both. Some possible conditions are discussed further below. In this embodiment, CtP, CtF or any other exposure method as known in the art may be used. The condition that is used in generating a non-printing dot in a set of contiguous microdots may depend on a characteristic of the original image, on a characteristic of the set of contiguous microdots, or on both. Characteristics of the non-printing dots, such as their dot size, may also be taken into account. Some examples of such characteristics are: the set of contiguous microdots represents text (this is a characteristic of the original image); the border of the set of contiguous microdots (which is a characteristic of the set of contiguous microdots).

In a preferred embodiment of the invention, non-printing dots are generated conditionally and direct-to-plate exposure is used.

The non-printing dots may be generated when generating the screen tiles via the threshold matrices (see e.g. U.S. Pat. No. 5,766,807 for more information on tiles, threshold matrices and other screening related terms). The non-printing dots may also be generated by controlling the raster image processor (RIP). These implementations are discussed in detail further below.

Further advantages and embodiments of the present invention will become apparent from the following description and drawings.

### BRIEF DESCRIPTION OF THE DRAWINGS

The invention is described with reference to the following drawings without the intention to limit the invention thereto, and in which:

FIG. 1 shows a morphological filter;

FIGS. 2 and 3 illustrate an embodiment in accordance with the invention.

### DETAILED DESCRIPTION OF THE INVENTION

Some possible conditions that may be used in generating a non-printing dot are discussed now; these conditions may also be combined.

In a first embodiment, non-printing dots are generated in image dots in such a way that the resulting image dots (i.e. the image dots after their combination with the non-printing dots) are at least equal to a predetermined dot size. This predetermined dot size may be the size of the minimum printable dot for a given printing process, i.e. the smallest dot that can still be reproduced consistently (as discussed e.g. in U.S. Pat. No. 5,766,807, cited already above).

In a second embodiment, non-printing dots are generated in such a way that fine details, e.g. hair lines, in the original image are preserved.

In a third embodiment, the number of non-printing dots in a set of contiguous microdots increases with increasing size of the set of contiguous microdots.

In a fourth embodiment, the outer circumference of the image dot is taken into account. The location of the non-printing dots is chosen so as to keep a small outer circumference of the resulting image dot (after combination with the non-printing dots). With c the outer circumference of the image dot before the combination with the non-printing dots, the outer circumference of the resulting image dot is preferably smaller than 1.25*c, more preferably smaller than 1.1*c and most preferably smaller than 1.05*c. In this way, the resulting image dots are compact, which avoids that too much ink clings to them on the press.

In a fifth embodiment, text is preserved, i.e. no non-printing dots are generated in sets of contiguous microdots representing text.

In a sixth embodiment, non-printing dots are only generated in text having a text size larger than a predetermined text size.

In a seventh embodiment, the borders of selected sets of contiguous microdots are preserved, i.e. no non-printing dots are generated in the borders of these sets of contiguous microdots.

In an eighth embodiment, text borders are preserved, i.e. text borders are free of non-printing dots.

Non-printing dots may be generated in different ways, e.g. via the screen tiles or via the RIP.

When generating non-printing dots via the screen tiles, a minimum image dot size, e.g. equal to the size of a minimum printable dot, may be implemented as follows. A non-printing dot is represented in the threshold matrix by one or more adjoining microdots with, depending on the environment (e.g. PostScript is such an environment) either a very high threshold value (“infinity”) or a very low threshold value (e.g. zero), so that these microdots will never be turned on. Further, the microdots that represent a non-printing dot are located in the threshold matrix “outside” of the zone that corresponds to the minimum dot size (this zone may be a square of 2*2 microdots in the threshold matrix in case the minimum image dot size is four microdots).

Moreover, a transfer function may be used that maps 100% black (or 100% of another color) to a lower value, say 99.9% black (or 99.9% of another color). The reason for using such a transfer function is that in some environments no tile is used for 100% black, so that no non-printing dots would be generated in that case. When using such a transfer function for full color areas, these areas will be screened, so that non-printing dots will be generated in these areas, via the screen tiles.

When generating non-printing dots via the RIP, a morphological filter may be applied to a set of contiguous microdots, or to the entire bitmap, in order to preserve fine details (such as hair lines). This is illustrated by the following example. In a square of 3*3=9 microdots, at least seven microdots have to be turned on, i.e. will be printed black, before one of the microdots is replaced by a non-printing dot, i.e. a “white hole”. A hair line, with three of the nine microdots turned on in the 3*3 square, thus remains unchanged. If on the other hand eight of the nine microdots are turned on, a non-printing dot may be generated, depending on the value of a random number.

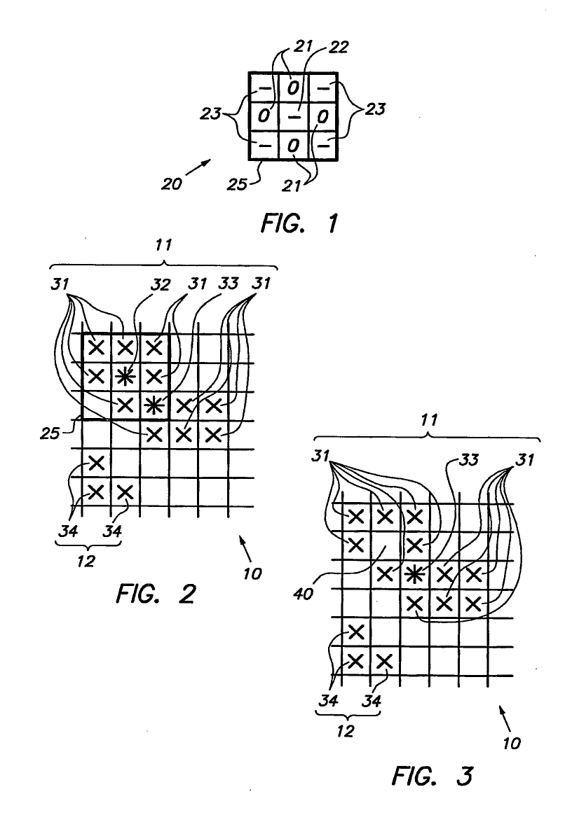

FIG. 1 shows another morphological filter 20, that is also defined by means of a square of 3*3 microdots. The square contains a central location 22, four locations 21 forming a rectangular cross together with the central location 22, and four remaining locations 23. This morphological filter 20 is applied to a bitmap, e.g. to the bitmap 10 shown in FIG. 2, as follows.

The bitmap 10 shown in FIG. 2 contains two sets 11, 12 of contiguous microdots. Set 12 contains the microdots 34, while set 11 contains the microdots 31, 32 and 33. In FIG. 2, and also in FIG. 3, the microdots 31-34 are represented symbolically by a “x” or a “*”. First, possible locations for non-printing dots are determined; this is discussed further below. In case microdot 32 is a candidate for being removed by generating a non-printing dot at its location, the morphological filter 20 is positioned as indicated by its border 25 and with its central location 22 corresponding to the candidate, microdot 32. The morphological filter 20 is now applied as a mask: if bitmap 10 contains turned on microdots 31 at all the locations 21 of the morphological filter 20 (which is the case in the illustrated example), then microdot 32, at the central location 22 of the morphological filter 20, will be removed, i.e. replaced by a non-printing dot 40. This is shown in FIG. 3, which represents the bitmap 10 after application of the morphological filter 20. The shape of the morphological filter 20 shown in FIG. 1 is so that microdots at the border of a set of contiguous microdots, such as microdots 34 in FIG. 2, will not be removed. This morphological filter 20 can thus be used to preserve the borders of sets of contiguous microdots. As is clear from FIG. 1 and FIG. 2, at the location of microdot 33 another non-printing dot may be generated without affecting the border of the set 11 of contiguous microdots.

In a preferred embodiment of the invention, possible locations for non-printing dots are determined and non-printing dots are generated conditionally, i.e. only at the locations where a predetermined condition is satisfied. The possible locations may be determined in accordance with an AM screen, preferably a fine AM screen with a high screen ruling of 120 lpi (lines per inch) or more; alternatively, an FM screen or stochastic screen may be used to determine the possible locations for non-printing dots. For example a CristalRaster™ screen may be generated that corresponds with a density of 10%. The locations of the generated FM dots are the locations where, subject to a predetermined condition, the non-printing dots will be generated.

In the example illustrated by FIGS. 2 and 3, microdot 32 is determined as a possible location for a non-printing dot, but microdot 33 is not, so that only one non-printing dot 40 is generated, at the location of microdot 32, as shown by FIG. 3.

In the examples discussed above, the symbols “x” and “*” in FIGS. 2 and 3 represent a single microdot, and a non-printing dot has a size of only one microdot. In a preferred embodiment in accordance with the invention, the non-printing dots have a larger size. Preferred sizes are 2×2 microdots and 3×3 microdots. If a morphological filter is applied, it will then handle units of this larger size (such as 2×2 or 3×3)—in FIG. 1, each location 21, 22, 23 then has a size of e.g. 2×2 microdots. Larger morphological filters may also be used; an advantage is that much more sophisticated conditions may be applied.

Another example illustrating the invention is a black solid area that includes white text. When using the condition that text borders are to be preserved, (white) non-printing dots will be generated in the black solid area, and the text border will be free of non-printing dots.

The invention is not limited to the embodiments discussed above; e.g. a different morphological filter may be applied, that may have a size of 3*3 units (wherein each unit contains e.g. 2×2 microdots), or it may have a size of 5*5 units, or still another size.

It is preferred that the condition to generate non-printing dots is evaluated at the level of the frame buffer of the Raster Image Processor (RIP), i.e. where the bitmap, or at least a portion of it, is stored; this allows a high speed implementation of the invention. In a specific embodiment, a morphological filter is applied to the RIP's frame buffer.

The original image that is to be reproduced may be split into objects, such as text objects; solid area objects, contone image objects, etc. Generating non-printing dots may then be implemented by means of operators on these objects: an operator transforms an object into an object that includes non-printing dots. The operators may depend on the kind of objects they handle, so that e.g. borders of text objects are preserved.

In yet another implementation of the invention, the original image is partitioned into a number of portions, by means of a low pass filter: non-printing dots are only generated in the low frequency portions of the image, not in the high frequency portions.

The invention can be applied to positive printing plates and to negative printing plates. Normally, in a system with positive printing plates, microdots that are turned on in the bitmap correspond to locations on the printing plate that will not be exposed, that are inkphilic and that will carry ink during reproduction of the original image (see further U.S. Pat. No. 6,406,833, cited already above, for positive and negative plates). However, a case for negative plates can easily be generated from a case for positive plates by means of a simple transformation, e.g. by transforming all pixel values x to 255−x (if the possible pixel values are 0 to 255).

The invention includes a method as disclosed above and as claimed in the appending claims. The invention also includes a printing plate and a printing plate precursor made by a method in accordance with the invention. Such a printing plate or printing plate precursor has non-ink-accepting areas corresponding to the non-printing dots generated by a method in accordance with the invention.

Those skilled in the art will appreciate that numerous modifications and variations may be made to the embodiments disclosed above without departing from the scope of the present invention.

1. A method for generating a bitmap from an original image for printing a reproduction of said original image, wherein said bitmap includes data selected from the group of screened data and non-screened data, the method comprising the steps of:
generating a set of contiguous microdots of said bitmap, wherein said set of contiguous microdots is selected from the group of a set of contiguous microdots forming an image dot being part of said screened data and a set of contiguous microdots forming an entity of contiguous microdots being part of said non-screened data;
generating a non-printing dot in said set of contiguous microdots, depending on a specific characteristic selected from a characteristic of said original image and a characteristic of said set of contiguous microdots; and
applying a morphological filter to said set of contiguous microdots for preserving fine details in said reproduction of said original image.

2. The method according to claim 1 further comprising the steps of:
determining a possible location in said set of contiguous microdots for said non-printing dot;
checking if said possible location fulfills a condition, wherein said condition depends on said specific characteristic; and
generating said non-printing dot only if said condition is fulfilled.

3. The method according to claim 1 wherein said specific characteristic is said characteristic of said original image.

4. The method according to claim 1 wherein said specific characteristic is said characteristic of said set of contiguous microdots.

5. The method according to claim 4 wherein said specific characteristic is a dot size of said image dot and wherein the method further comprises the step of:
generating said non-printing dot in said image dot only if said dot size of said image dot is larger than a predetermined minimum size.

6. The method according to claim 1 further comprising the step of:
determining said set of contiguous microdots by a raster image processor having a frame buffer.

7. (canceled)

8. The method according to claim 6 further comprising the step of:
applying said morphological filter to said set of contiguous microdots in said frame buffer.

9. The method according to claim 1 further comprising the step of:
applying a second morphological filter to said bitmap for preserving fine details in said reproduction of said original image.

10. The method according to claim 1 further comprising the step of:
exposing a printing plate precursor in accordance with said bitmap.

11. The method according to claim 10 wherein said exposure is a direct-to-plate exposure.

12-13. (canceled)

14. A printing plate obtained by the method according to to claim 1.

15. A data processing system comprising means for carrying out the steps of the method according to claim 1.

16. A computer program comprising computer program code means adapted to perform the method according to claim 1 when said program is run on a computer.

17. A computer readable medium comprising program code adapted to carry out the method according to claim 1 when run on a computer.

18. A method for generating a bitmap from an original image for printing a reproduction of said original image, wherein said bitmap includes data selected from the group of screened data and non-screened data, the method comprising the steps of:
generating, in a raster image processor having a frame buffer, a set of contiguous microdots of said bitmap for storage into the frame buffer, wherein said set of contiguous microdots is selected from the group of a set of contiguous microdots forming an image dot being part of said screened data and a set of contiguous microdots forming an entity of contiguous microdots being part of said non-screened data;
generating a non-printing dot in said set of contiguous microdots, depending on a specific characteristic selected from a characteristic of said original image and a characteristic of said set of contiguous microdots; and
applying a morphological filter to said set of contiguous microdots in said frame buffer for preserving fine details in said reproduction of said original image.

19. The method according to claim 18 further comprising the step of applying a second morphological filter to said bitmap for preserving fine details in said reproduction of said original image.

20. A method for generating a bitmap from an original image for printing a reproduction of said original image, wherein said bitmap includes data selected from the group of screened data and non-screened data, the method comprising the steps of:
generating a set of contiguous microdots of said bitmap, wherein said set of contiguous microdots is selected from the group of a set of contiguous microdots forming an image dot being part of said screened data and a set of contiguous microdots forming an entity of contiguous microdots being part of said non-screened data;
generating a non-printing dot in said set of contiguous microdots, depending on a specific characteristic selected from a characteristic of said original image and a characteristic of said set of contiguous microdots;
applying a morphological filter to said set of contiguous microdots for preserving fine details in said reproduction of said original image; and
exposing a printing plate precursor in accordance with said bitmap wherein said exposure is a direct-to-plate exposure.

21. The method according to claim 20 further comprising the step of applying a second morphological filter to said bitmap for preserving fine details in said reproduction of said original image.

22. A method for generating a bitmap from an original image for printing a reproduction of said original image, wherein said bitmap includes data selected from the group of screened data and non-screened data, the method comprising the steps of:
generating a set of contiguous microdots of said bitmap by a raster image processor having a frame buffer, wherein said set of contiguous microdots is selected from the group of a set of contiguous microdots forming an image dot being part of said screened data and a set of contiguous microdots forming an entity of contiguous microdots being part of said non-screened data;
generating a non-printing dot in said set of contiguous microdots, depending on a specific characteristic selected from a characteristic of said original image and a characteristic of said set of contiguous microdots;
applying a morphological filter to said set of contiguous microdots in said frame buffer for preserving fine details in said reproduction of said original image; and
exposing a printing plate precursor in accordance with said bitmap wherein said exposure is a direct-to-plate exposure.

23. The method according to claim 22 further comprising the step of applying a second morphological filter to said bitmap for preserving fine details in said reproduction of said original image.
